(19) United States
(12) Patent Application Publication
(10) Pub. No.: US 2026/0106070 A1
(43) Pub. Date: Apr. 16, 2026

(54) COIL COMPONENT

(71) Applicant: TDK CORPORATION, Tokyo (JP)

(72) Inventors: Tomonaga NISHIKAWA, Tokyo (JP); Masumi KAMEDA, Tokyo (JP); Takafumi ONO, Akita (JP); Sojiro MOCHIDA, Akita (JP); Daiki TSUJI, Tokyo (JP)

(21) Appl. No.: 19/348,020

(22) Filed: Oct. 2, 2025

(30) Foreign Application Priority Data
Oct. 10, 2024 (JP) 2024-177750

(51) Int. Cl. H01F 27/32; H01F 5/00; H01F 5/06; H01F 27/255; H01F 27/29

(52) U.S. Cl. CPC H01F 27/324; H01F 5/003; H01F 5/06; H01F 27/255; H01F 27/292; H01F 27/323

(57) ABSTRACT

Disclosed herein is a coil component that includes: an element body having a mounting surface; a coil part embedded in the element body, the coil part including a plurality of conductor layers stacked in a stacking direction parallel to the mounting surface; an insulating resin positioned between the element body and the coil part; a first terminal electrode connected to one end of the coil part and provided so as to protrude from the mounting surface; and a second terminal electrode connected to other end of the coil part and provided so as to protrude from the mounting surface. The insulating resin has a first exposed part positioned between the first and second terminal electrodes on the mounting surface and exposed so as to protrude from the mounting surface.

### CROSS-REFERENCE TO RELATED APPLICATION

This application claims the benefit of Japanese Patent Application No. 2024-177750, filed on Oct. 10, 2024, the entire disclosure of which is incorporated by reference herein.

### BACKGROUND OF THE ART

### Field of the Art

The present disclosure relates to a coil component and, more particularly, to a surface-mountable chip-type coil component.

### Description of Related Art

JP 2021-019088A discloses a surface-mountable chip-type coil component.

A circuit board mounting thereon this kind of coil component is sometimes subjected to surface sealing with a molding resin for modularization. However, upon the sealing, a solder is remelted by heat, with the result that there may occur a flash event in which terminal electrodes of the coil component are short-circuited due to the solder flow.

### SUMMARY

A coil component according to an aspect of the present disclosure includes: an element body having a mounting surface; a coil part embedded in the element body, the coil part including a plurality of conductor layers stacked in a stacking direction parallel to the mounting surface; an insulating resin positioned between the element body and the coil part; a first terminal electrode connected to one end of the coil part and provided so as to protrude from the mounting surface; and a second terminal electrode connected to other end of the coil part and provided so as to protrude from the mounting surface. The insulating resin has a first exposed part positioned between the first and second terminal electrodes on the mounting surface and exposed so as to protrude from the mounting surface. Thus, excessive flowability of a solder is suppressed due to the presence of the first exposed part protruding from the mounting surface, thus making a flash phenomenon unlikely to occur.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic perspective view illustrating the outer appearance of a coil component 100 according to an embodiment of the technology described herein;

FIG. 2 is a schematic plan view of the coil component 100;

FIG. 3 is a schematic plan view for explaining the structures of the respective conductor layer L1;

FIG. 4 is a schematic plan view for explaining the structures of the respective conductor layer L2;

FIG. 5 is a schematic plan view for explaining the structures of the respective conductor layer L3;

FIG. 6 is a schematic plan view for explaining the structures of the respective conductor layer L4;

FIG. 7 is a schematic cross-sectional view illustrating a state where the coil component 100 is mounted on a circuit board 200;

FIG. 8 is a schematic plan view for explaining the pattern shape of the conductor layer L1 immediately after formed;

FIG. 9 is a schematic plan view for explaining the pattern shape of the conductor layer L2 immediately after formed;

FIG. 10 is a schematic plan view for explaining the pattern shape of the conductor layer L3 immediately after formed;

FIG. 11 is a schematic plan view for explaining the pattern shape of the conductor layer L4 immediately after formed;

FIG. 12 is a schematic plan view of a coil component 100A according to a first modification; and

FIG. 13 is a schematic plan view of a coil component 100B according to a second modification.

### DETAILED DESCRIPTION OF THE EMBODIMENTS

The present disclosure describes a coil component in which a flash event is unlikely to occur on a circuit board.

Some embodiments of the present disclosure will be explained below in detail with reference to the accompanying drawings.

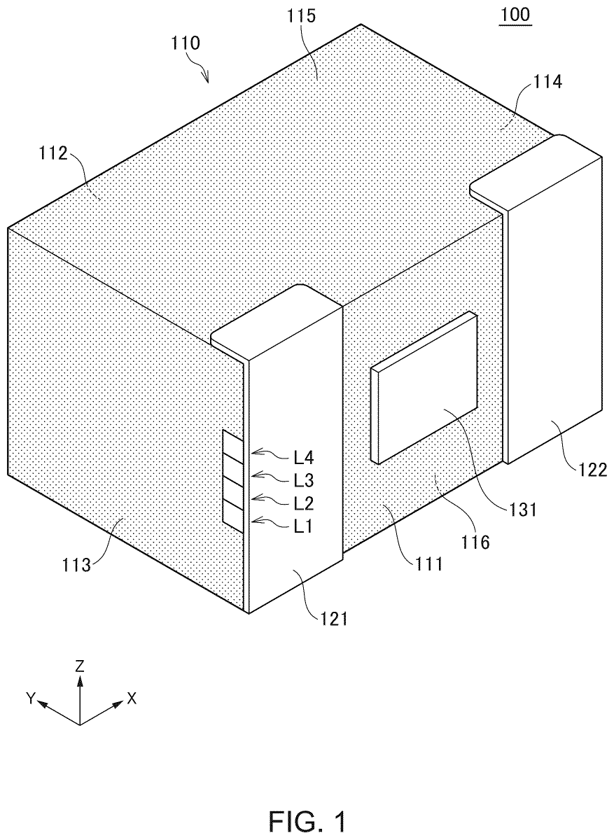

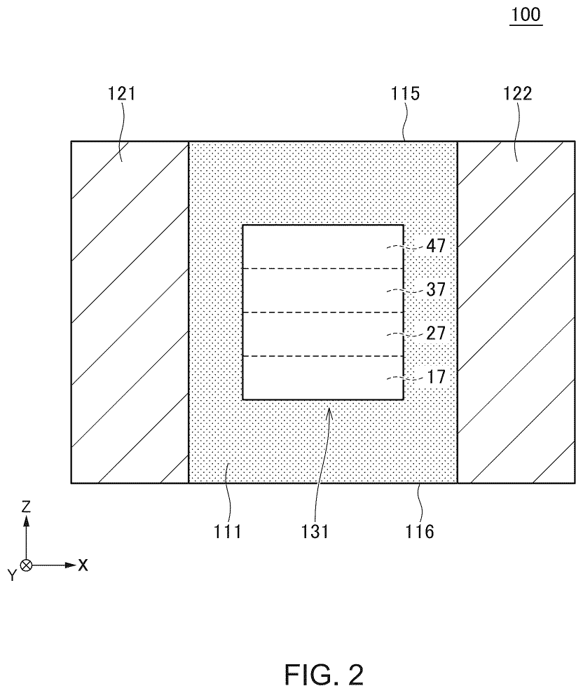

FIG. 1 is a schematic perspective view illustrating the outer appearance of a coil component 100 according to an embodiment of the technology described herein. FIG. 2 is a schematic plan view of the coil component 100.

As illustrated in FIGS. 1 and 2, the coil component 100 according to the present embodiment includes an element body 110 having a mounting surface 111 and a pair of terminal electrodes 121 and 122 provided on the mounting surface 111. As described later, a coil part including conductor layers L1 to L4 is embedded in the element body 110. One end of the coil part is connected to the terminal electrode 121, and the other end thereof is connected to the terminal electrode 122.

The element body 110 may be made of a composite magnetic material obtained by binding, with a resin binder, a magnetic filler made of a high-permeability material such as ferrite or permalloy. The element body 110 has the mounting surface 111, an upper surface 112, side surfaces 113 and 114, and side surfaces 115 and 116. The mounting surface 111 and upper surface 112 constitute the XZ plane and positioned on mutually opposite sides. The side surfaces 113 and 114 constitute the YZ plane and positioned on mutually opposite sides. The side surfaces 115 and 116 constitute the XY plane and positioned on mutually opposite sides.

The terminal electrode 121 is provided at the end portion of the mounting surface 111 of the element body 110 in the negative X-direction so as to protrude in the negative Y-direction from the mounting surface 111. The terminal electrode 122 is provided at the end portion of the mounting surface 111 of the element body 110 in the positive X-direction so as to protrude in the negative Y-direction from the mounting surface 111. The width of each of the terminal electrodes 121 and 122 in the Z-direction may be the same as the width of the mounting surface 111 in the Z-direction. Further, the terminal electrodes 121 and 122 may partially go around to the side surfaces 115 and 116 of the element body 110.

An exposed part 131 of an insulating resin protruding from the mounting surface 111 is exposed from the mounting surface 111 at a position between the terminal electrodes 121 and 122. The exposed part 131 is positioned at substantially the center of the mounting surface 111. The width of the exposed part 131 in the X-direction is smaller than the distance between the terminal electrodes 121 and 122 in the X-direction. The width of the exposed part 131 in the Z-direction is smaller than the width of the mounting surface 111 in the Z-direction. Thus, the exposed part 131 is surrounded by the mounting surface 111 of the element body 110 in a plan view as viewed in the Y-direction.

The coil component 100 according to the present embodiment has a configuration in which four conductor layers L1 to L4 constituting the coil part are embedded in the element body 110. These conductor layers L1 to L4 are stacked in the Z-direction parallel to the mounting surface 111.

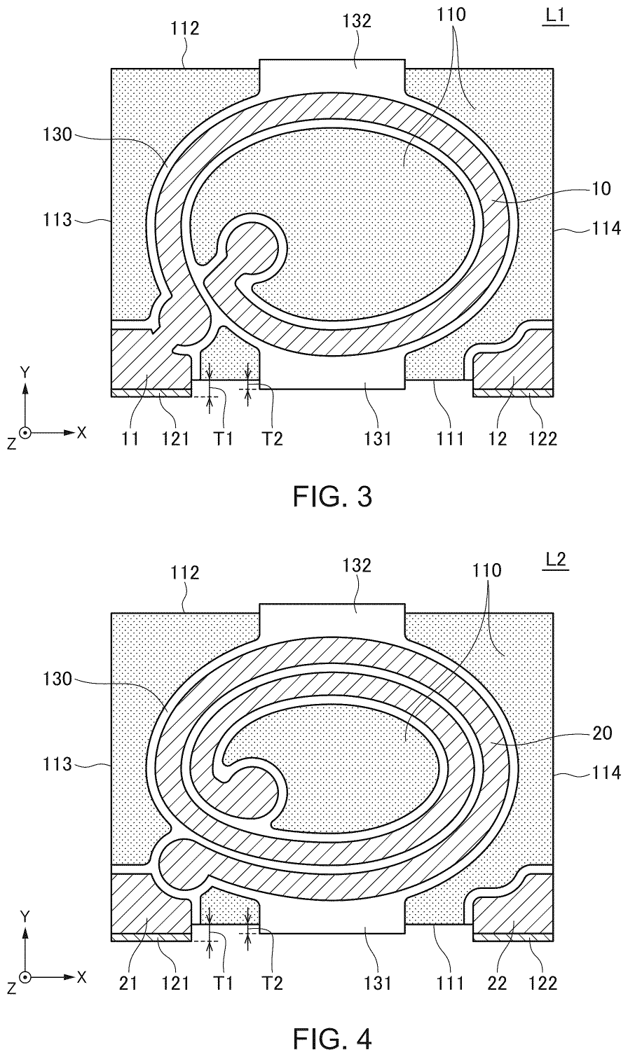

FIGS. 3 to 6 are schematic plan views for explaining the structures of the respective conductor layers L1 to L4.

The conductor layer L1 is positioned at the end portion in the negative Z-direction and is formed first in the manufacturing process. In the example illustrated in FIG. 3, the conductor layer L1 includes a coil pattern 10 wound in about one turn, a terminal pattern 11 connected to the outer peripheral end of the coil pattern 10, and a terminal pattern 12 separated from the coil pattern 10 and terminal pattern 11 within the surface. The terminal pattern 11 is exposed from the mounting surface 111 and side surface 113 of the element body 110, and the terminal pattern 12 is exposed from the mounting surface 111 and side surface 114 of the element body 110. An insulating resin 130 is provided between the conductor layer L1 and the element body 110 to thereby prevent contact therebetween. The insulating resin 130 may be made of a composite magnetic material obtained by binding, with a resin binder, an inorganic filler made of an insulating material such as silica.

The conductor layer L2 is the second conductor layer counted from the end portion in the negative Z-direction and formed after the conductor layer L1 is formed through the insulating resin 130 during manufacture. In the example illustrated in FIG. 4, the conductor layer L2 includes a coil pattern 20 wound in about two turns and terminal patterns 21 and 22 separated from the coil pattern 20 within the surface. The inner peripheral end of the coil pattern 20 is connected to the inner peripheral end of the coil pattern 10 positioned in the conductor layer L1 through a via formed in the insulating resin 130. The terminal patterns 21 and 22 are connected respectively to the terminal patterns 11 and 12 of the conductor layer L1 through vias formed in the insulating resin 130. The terminal pattern 21 is exposed from the mounting surface 111 and side surface 113 of the element body 110, and the terminal pattern 22 is exposed from the mounting surface 111 and side surface 114 of the element body 110. The insulating resin 130 is interposed between the conductor layer L2 and the element body 110 and between the conductor layers L1 and L2 to thereby separate the conductor layer L2 from the conductor layer L1 and to prevent the conductor layer L2 from contacting the element body 110.

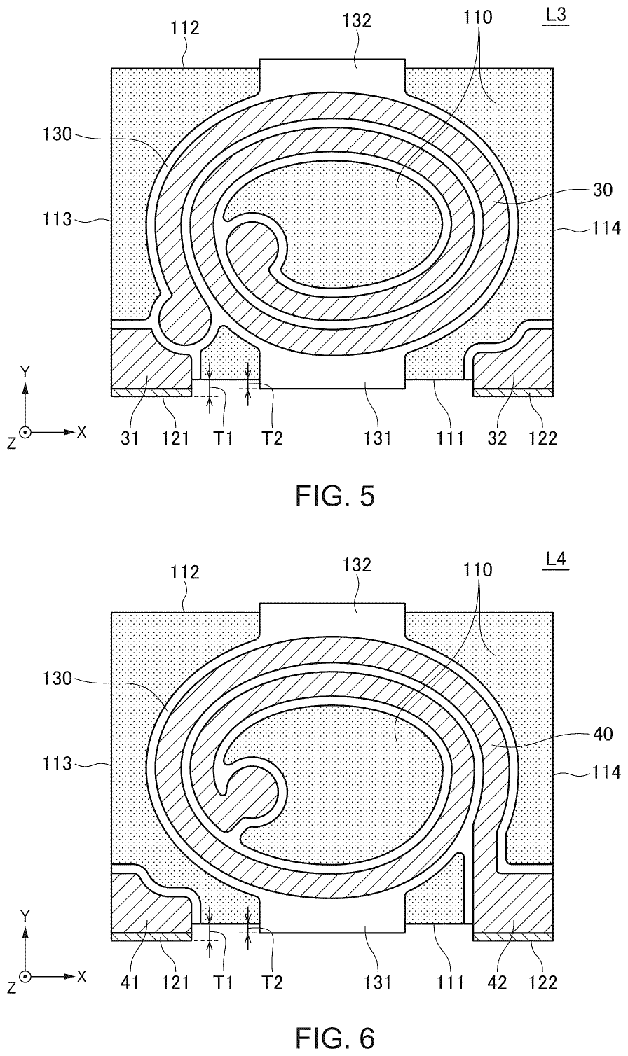

The conductor layer L3 is the third conductor layer counted from the end portion in the negative Z-direction and formed after the conductor layer L2 is formed through the insulating resin 130 during manufacture. In the example illustrated in FIG. 5, the conductor layer L3 includes a coil pattern 30 wound in about two turns and terminal patterns 31 and 32 separated from the coil pattern 30 within the surface. The outer peripheral end of the coil pattern 30 is connected to the outer peripheral end of the coil pattern 20 positioned in the conductor layer L2 through a via formed in the insulating resin 130. The terminal patterns 31 and 32 are connected respectively to the terminal patterns 21 and 22 of the conductor layer L2 through vias formed in the insulating resin 130. The terminal pattern 31 is exposed from the mounting surface 111 and side surface 113 of the element body 110, and the terminal pattern 32 is exposed from the mounting surface 111 and side surface 114 of the element body 110. The insulating resin 130 is interposed between the conductor layer L3 and the element body 110 and between the conductor layers L2 and L3 to thereby separate the conductor layer L3 from the conductor layer L2 and to prevent the conductor layer L3 from contacting the element body 110.

The conductor layer L4 is positioned at the end portion in the positive Z-direction and formed after the conductor layer L3 is formed through the insulating resin 130 during manufacture. In the example illustrated in FIG. 6, the conductor layer L4 includes a coil pattern 40 wound in about 1.5 turns, a terminal pattern 42 connected to the outer peripheral end of the coil pattern 40, and a terminal pattern 41 separated from the coil pattern 40 within the surface. The inner peripheral end of the coil pattern 40 is connected to the inner peripheral end of the coil pattern 30 positioned in the conductor layer L3 through a via formed in the insulating resin 130. The terminal patterns 41 and 42 are connected respectively to the terminal patterns 31 and 32 of the conductor layer L3 through vias formed in the insulating resin 130. The terminal pattern 41 is exposed from the mounting surface 111 and side surface 113 of the element body 110, and the terminal pattern 42 is exposed from the mounting surface 111 and side surface 114 of the element body 110. The insulating resin 130 is interposed between the conductor layer L4 and the element body 110 and between the conductor layers L3 and L4 to thereby separate the conductor layer L4 from the conductor layer L3 and to prevent the conductor layer L4 from contacting the element body 110.

As illustrated in FIGS. 3 to 6, the surfaces of the respective terminal patterns 11, 21, 31, and 41 exposed from the mounting surface 111 are covered with the terminal electrode 121. Similarly, the surfaces of the respective terminal patterns 12, 22, 32, and 42 exposed from the mounting surface 111 are covered with the terminal electrode 122. This results in that a coil part of about 6.5 turns composed of the coil patterns 10, 20, 30, and 40 is connected between the terminal electrodes 121 and 122. The XZ surfaces of the respective terminal electrodes 121 and 122 protrude in the negative Y-direction from the mounting surface 111. The protruding amount of the XZ surface of each of the terminal electrodes 121 and 122 in the Y-direction from the mounting surface 111 is T1.

Further, as illustrated in FIGS. 3 to 6, a part of the insulating resin 130 constitutes the exposed part 131 exposed so as to protrude in the negative Y-direction from the mounting surface 111 of the element body 110. The protruding amount of the XZ surface of the exposed part 131 in the Y-direction from the mounting surface 111 is T2. Another part of the insulating resin 130 may constitute an exposed part 132 exposed so as to protrude in the positive Y-direction from the upper surface 112 of the element body 110.

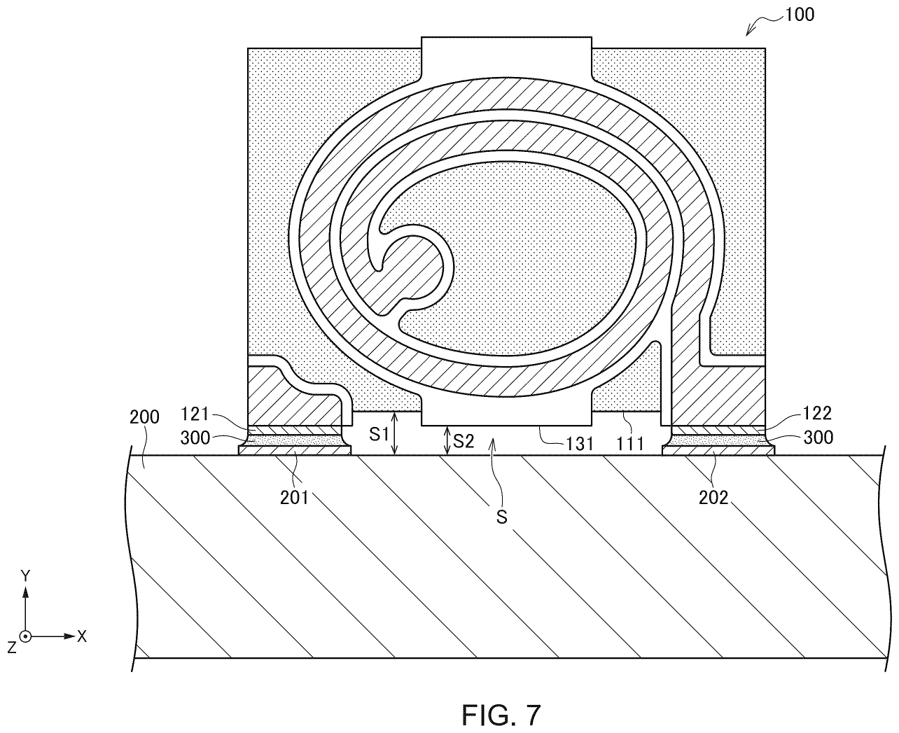

FIG. 7 is a schematic cross-sectional view illustrating a state where the coil component 100 according to the present embodiment is mounted on a circuit board 200.

As illustrated in FIG. 7, the circuit board 200 has land patterns 201 and 202. In a state where the coil component 100 according to the present embodiment is mounted on the circuit board 200, the terminal electrodes 121 and 122 of the coil component 100 are connected respectively to the land patterns 201 and 202 through a solder 300. As a result, a space S is formed between the coil component 100 and the circuit board 200. The space S includes a space S1 positioned between the surface of the circuit board 200 and the mounting surface 111 of the element body 110 and a space S2 positioned between the surface of the circuit board 200 and the exposed part 131 of the insulating resin 130. The width of the space S2 in the Y-direction is smaller than the width of the space S1 in the Y-direction. The difference in width between the spaces S1 and S2 corresponds to the protruding amount T2 illustrated in FIG. 3 (S1−S2=T2).

After the coil component 100 is thus surface-mounted on the circuit board 200, the surface of the circuit board 200 is sealed with a molding resin. Then, the molding resin enters the spaces S1 and S2, with the result that the spaces S1 and S2 are filled with the molding resin. As described using FIGS. 3 to 6, the surfaces of the respective terminal electrodes 121 and 122 protrude from the mounting surface 111, so that the space S1 is sufficiently ensured, thus facilitating entering of the molding resin.

Here, when the solder 300 is remelted by heat during the molding, there may occur a flash phenomenon in which terminal electrodes 121 and 122 are short-circuited due to the flow of the solder 300. However, in the present embodiment, the surface of the coil component 100 that faces the surface of the circuit board 200 is not flat, that is, the exposed part 131 protruding from the mounting surface 111 is present at a portion between the terminal electrodes 121 and 122, so that excessive flowability of the remelted solder 300 is suppressed due to the presence of the exposed part 131, thus making the flash phenomenon unlikely to occur.

Although the space S2 is narrower than the space S1, the surface of the exposed part 131 of the insulating resin 130 is higher in flatness than the mounting surface 111 of the element body 110, allowing the molding resin to easily enter even the narrow space S2. Thus, the filling performance of the molding resin is not significantly impaired due to the presence of the exposed part 131 protruding from the mounting surface 111. To enhance the flatness of the surface of the exposed part 131, a filler having an average particle diameter smaller than that of a filler contained in the element body 110 is used for the insulating resin 130. Further, by making the protruding amount T1 of each of the terminal electrodes 121 and 122 from the mounting surface 111 larger than the protruding amount T2 of the exposed part 131 from the mounting surface 111, the space S2 is further enlarged, making it possible to further enhance the filling performance of the molding resin.

Further, as described using FIG. 2, when the width of the exposed part 131 in the X-direction is made smaller than the distance between the terminal electrodes 121 and 122 in the X-direction, the molding resin entering the space S1 can sufficiently flow in the Z-direction, making voids unlikely to occur in the space S1. Furthermore, when the width of the exposed part 131 in the Z-direction is made smaller than the width of the mounting surface 111 in the Z-direction, the molding resin can easily enter the space S between the coil component 100 and the circuit board 200.

The following describes a manufacturing method for the coil component 100 according to the present embodiment.

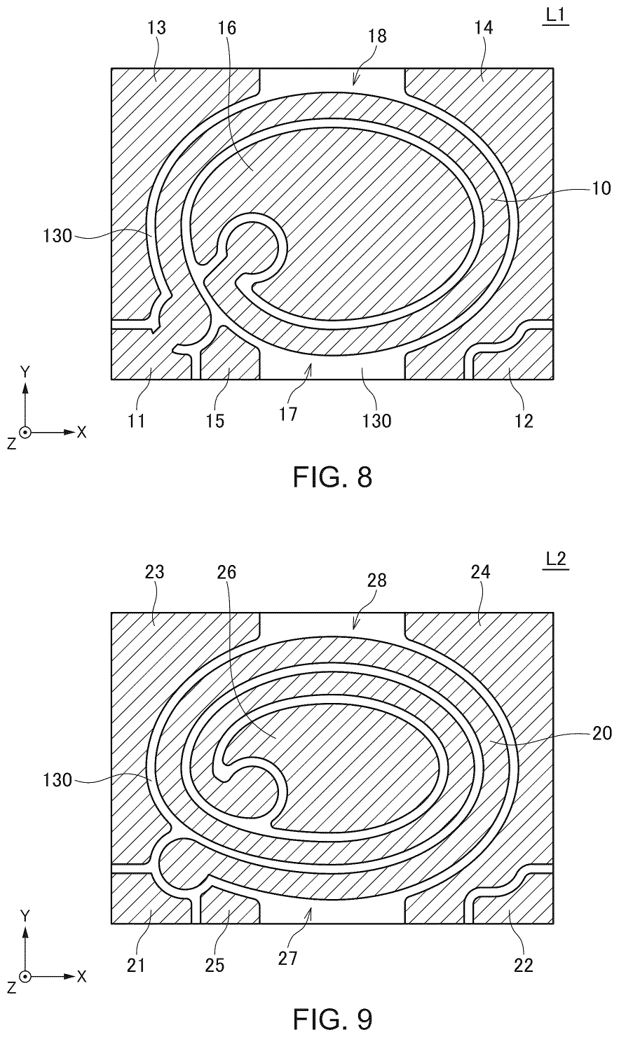

As illustrated in FIG. 8, the conductor layer L1 is formed on a substrate through the insulating resin 130. In this stage, the conductor layer L1 includes not only the coil pattern 10 and terminal patterns 11 and 12 but also sacrificial patterns 13 to 16. The sacrificial patterns 13 to 15 are positioned radially outside the coil pattern 10, and the sacrificial pattern 16 is positioned at an area surrounded by the coil pattern 10. Here, with respect to the center of the coil pattern 10, the sacrificial patterns 13 and 15 are positioned on the negative X-direction side, and the sacrificial pattern 14 is positioned on the positive X-direction side. The sacrificial patterns 14 and 15 are not integrated but separated from each other with an area 17 interposed therebetween. Similarly, the sacrificial patterns 13 and 14 are not integrated but separated from each other with an area 18 interposed therebetween. Thereafter, the insulating resin 130 is formed so as to cover the conductor layer L1. Thus, a space between the coil pattern 10 and the sacrificial patterns 13 to 16 and a space between the terminal patterns 11 and 12 and the sacrificial patterns 13 to 16 are filled with the insulating resin 130. The areas 17 and 18 are also filled with the insulating resin 130.

Then, as illustrated in FIG. 9, the conductor layer L2 is formed on the conductor layer L1 through the insulating resin 130. In this stage, the conductor layer L2 includes not only the coil pattern 20 and terminal patterns 21 and 22 but also sacrificial patterns 23 to 26. The sacrificial patterns 23 to 25 are positioned radially outside the coil pattern 20, and the sacrificial pattern 26 is positioned at an area surrounded by the coil pattern 20. Here, with respect to the center of the coil pattern 20, the sacrificial patterns 23 and 25 are positioned on the negative X-direction side, and the sacrificial pattern 24 is positioned on the positive X-direction side. The sacrificial patterns 24 and 25 are not integrated but separated from each other with an area 27 interposed therebetween. Similarly, the sacrificial patterns 23 and 24 are not integrated but separated from each other with an area 28 interposed therebetween. Thereafter, the insulating resin 130 is formed so as to cover the conductor layer L2. Thus, a space between the coil pattern 20 and the sacrificial patterns 23 to 26 and a space between the terminal patterns 21 and 22 and the sacrificial patterns 23 to 26 are filled with the insulating resin 130. The areas 27 and 28 are also filled with the insulating resin 130.

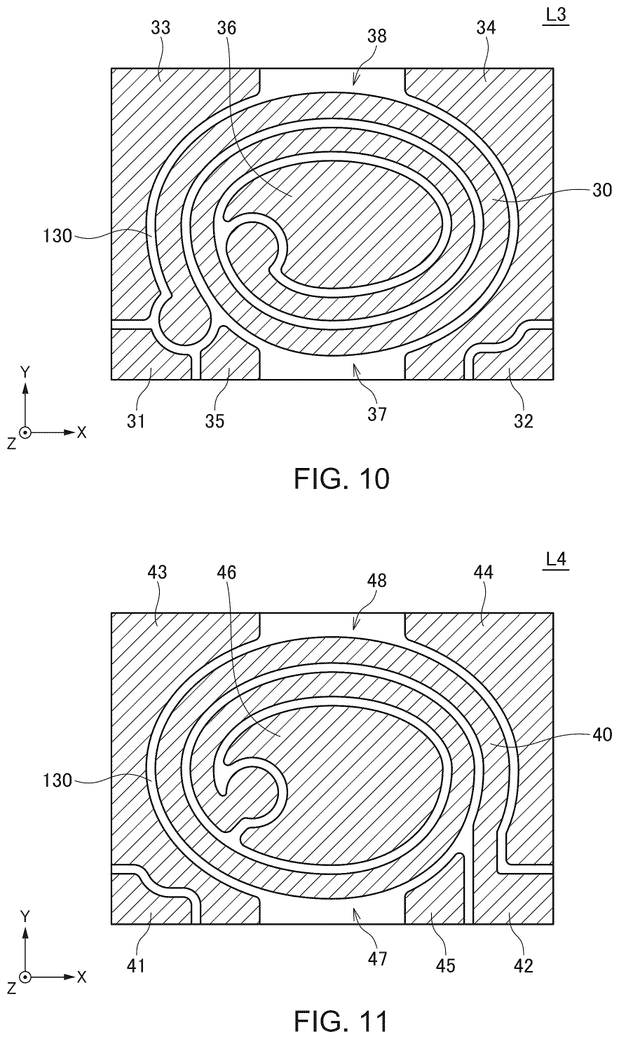

Then, as illustrated in FIG. 10, the conductor layer L3 is formed on the conductor layer L2 through the insulating resin 130. In this stage, the conductor layer L3 includes not only the coil pattern 30 and terminal patterns 31 and 32 but also sacrificial patterns 33 to 36. The sacrificial patterns 33 to 35 are positioned radially outside the coil pattern 30, and the sacrificial pattern 36 is positioned at an area surrounded by the coil pattern 30. Here, with respect to the center of the coil pattern 30, the sacrificial patterns 33 and 35 are positioned on the negative X-direction side, and the sacrificial pattern 34 is positioned on the positive X-direction side. The sacrificial patterns 34 and 35 are not integrated but separated from each other with an area 37 interposed therebetween. Similarly, the sacrificial patterns 33 and 34 are not integrated but separated from each other with an area 38 interposed therebetween. Thereafter, the insulating resin 130 is formed so as to cover the conductor layer L3. Thus, a space between the coil pattern 30 and the sacrificial patterns 33 to 36 and a space between the terminal patterns 31 and 32 and the sacrificial patterns 33 to 36 are filled with the insulating resin 130. The areas 37 and 38 are also filled with the insulating resin 130.

Then, as illustrated in FIG. 11, the conductor layer L4 is formed on the conductor layer L3 through the insulating resin 130. In this stage, the conductor layer L4 includes not only the coil pattern 40 and terminal patterns 41 and 42 but also sacrificial patterns 43 to 46. The sacrificial patterns 43 to 45 are positioned radially outside the coil pattern 40, and the sacrificial pattern 46 is positioned at an area surrounded by the coil pattern 40. Here, with respect to the center of the coil pattern 40, the sacrificial pattern 43 is positioned on the negative X-direction side, and the sacrificial patterns 44 and 45 are positioned on the positive X-direction side. The sacrificial patterns 43 and 45 are not integrated but separated from each other with an area 47 interposed therebetween. Similarly, the sacrificial patterns 43 and 44 are not integrated but separated from each other with an area 48 interposed therebetween. Thereafter, the insulating resin 130 is formed so as to cover the conductor layer L4. Thus, a space between the coil pattern 40 and the sacrificial patterns 43 to 46 and a space between the terminal patterns 41 and 42 and the sacrificial patterns 43 to 46 are filled with the insulating resin 130. The areas 47 and 48 are also filled with the insulating resin 130.

Then, the sacrificial patterns 13 to 16, 23 to 26, 33 to 36, and 43 to 46 are removed using acid or the like. As a result, spaces are formed in the areas where the sacrificial patterns 13 to 16, 23 to 26, 33 to 36, and 43 to 46 were present. In this state, the conductor layers L1 to L4 are embedded in the element body 110. As a result, the areas where the sacrificial patterns 13 to 16, 23 to 26, 33 to 36, and 43 to 46 were present are filled with the element body 110. After that, a precursor of the coil component 100 is singulated by dicing.

After the precursor is singulated by dicing, the insulating resin 130 filled in the areas 17, 27, 37, and 47 are exposed from the mounting surface 111 of the element body 110, and the insulating resin 130 filled in the areas 18, 28, 38, and 48 are exposed from the upper surface 112 of the element body 110. Immediately after the dicing, particles of the filler exposed to the surface of the element body 110 are likely to fall off. To prevent such falling-off of the filler particles, the surface of the element body 110 is subjected to selective etching. As a result, the surface layer of the element body 110 is removed, so that, as illustrated in FIGS. 3 to 6, the terminal patterns 11, 12, 21, 22, 31, 32, 41, and 42 protrude from the mounting surface 111, and the exposed part 131 of the insulating resin 130 protrudes from the mounting surface 111. Further, on the upper surface side of the element body 110, the exposed part 132 of the insulating resin 130 protrudes from the upper surface 112.

Thereafter, the terminal electrode 121 is formed so as to contact the terminal patterns 11, 21, 31, and 41, and the terminal electrode 122 is formed so as to contact the terminal patterns 12, 22, 32, and 42. Thus, the coil component 100 according to the present embodiment is completed.

As described above, in the manufacturing process of the coil component according to the present embodiment, there are provided the areas 17, 27, 37, and 47 in each of which the sacrificial pattern is not formed, so that, as illustrated in FIG. 2, the insulating resin 130 filled in the areas 17, 27, 37, and 47 can be exposed from the mounting surface 111 of the element body 110. Then, by selectively etching the surface layer of the element body 110 after the dicing, it is possible to make the terminal patterns 11, 12, 21, 22, 31, 32, 41, and 42 protrude from the mounting surface 111 and make the exposed part 131 of the insulating resin 130 protrude from the mounting surface 111.

In addition, the areas 17, 27, 37, and 47 are small in thickness in the Y-direction, so that if the element body 110 is provided in these areas, the thickness of the element body 110 in the Y-direction becomes insufficient at this portion. In this case, at this portion, cracks may be generated in the element body 110. On the other hand, such cracks are unlikely to occur in the insulating resin 130, so that by filling the areas 17, 27, 37, and 47 with the thin insulating resin 130, it is possible to enlarge the outer diameter size of the coil patterns 10, 20, 30, and 40 within the limited XY plane size, allowing a higher inductance to be obtained. The same can be said for the areas 18, 28, 38, and 48.

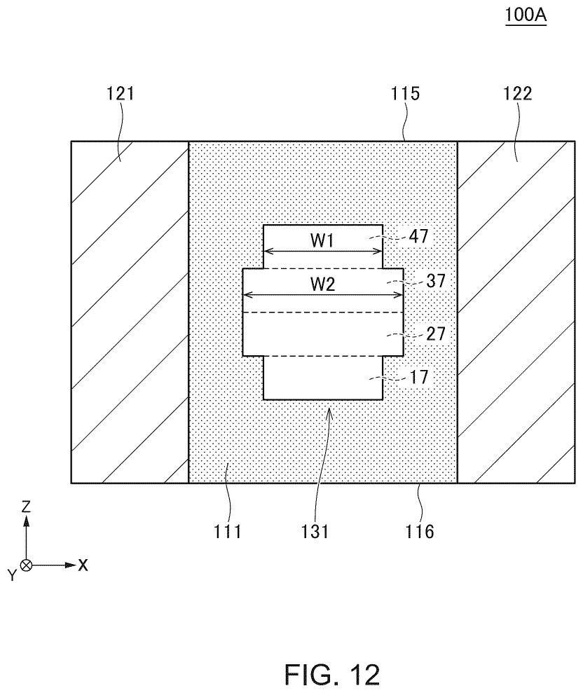

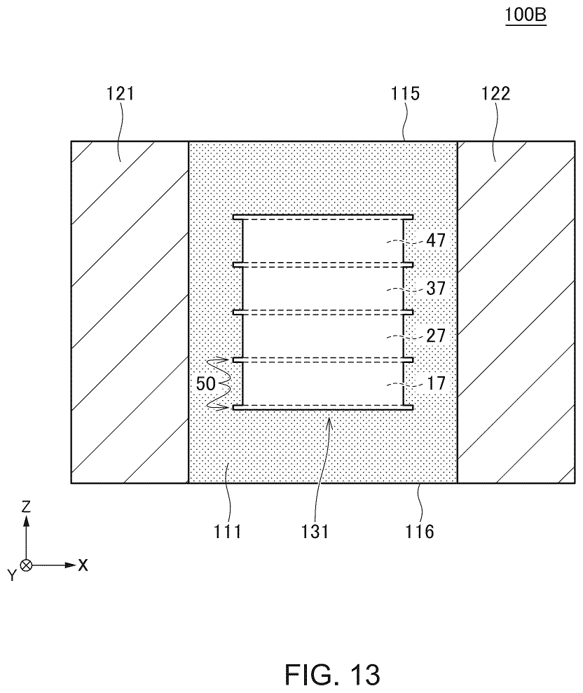

FIG. 12 is a schematic plan view of a coil component 100A according to a first modification. FIG. 13 is a schematic plan view of a coil component 100B according to a second modification.

As illustrated in FIGS. 12 and 13, the coil components 100A and 100B according to the first and second modifications differ from the coil component 100 according to the above embodiment in the shape of the exposed part 131 of the insulating resin 130. Other basic configurations are the same as those of the coil component 100 according to the above embodiment, so the same reference numerals are given to the same elements, and overlapping description will be omitted.

In the coil component 100A according to the first modification, a part of the exposed part 131 of the insulating resin 130 that is located in the stacking position (i.e., the position corresponding to the areas 27 and 37) same as the conductor layers L2 and L3 has an exposed width W2 larger than the exposed width of the remaining part of the exposed part 131 that is located in the stacking position (i.e., the position corresponding to the areas 17 and 47) same as the conductor layers L1 and L4. The exposed widths W1 and W2 each refer to the width in the X-direction perpendicular to the stacking direction. The above configuration can be obtained by making the diameters of the coil patterns 10 and 40 larger than those of the coil patterns 20 and 30. When the diameters of the coil patterns 10 and 40 are thus made larger than those of the coil patterns 20 and 30, the element body 110 easily enters the areas (spaces formed by the removal of the sacrificial patterns 16, 26, 36, and 46) surrounded by the coil patterns 10, 20, 30, and 40, thereby making it possible to reduce process difficulty during manufacture.

In the coil component 100B according to the second modification, the exposed part 131 of the insulating resin 130 is located not only in the stacking position (i.e., the position corresponding to the areas 17, 27, 37, and 47) same as the conductor layers L1 to L4 but also in an interlayer 50 (i.e., the area above and below each of the areas 17, 27, 37, and 47). In the exposed part 131 of the second modification, the exposed width in the X-direction of the insulating resin 130 located in the interlayer 50 is larger than that of the insulating resin 130 located in each of the areas 17, 27, 37, and 47. As a result, the boundary along the Z-direction between the mounting surface 111 and the exposed part 131 is not flat but has an irregular shape (specifically, extends in a zig-zag or meander manner). Thus, adhesion of the molding resin entering the space S1 is enhanced due to anchor effect of the irregular shape of the boundary.

While some embodiments of the technology according to the present disclosure have been described, the technology according to the present disclosure is not limited to the above embodiments, and various modifications may be made within the scope of the present disclosure, and all such modifications are included in the technology according to the present disclosure.

For example, although the coil component 100 according to the above embodiment has a configuration in which the four conductor layers L1 to L4 are embedded in the element body 110, the number of the stacking conductor layers to be embedded in the element body is not limited to this.

The technology according to the present disclosure includes the following configuration examples, but not limited thereto.

A coil component according to an aspect of the present disclosure includes: an element body having a mounting surface; a coil part embedded in the element body, the coil part including a plurality of conductor layers stacked in a stacking direction parallel to the mounting surface; an insulating resin positioned between the element body and the coil part; a first terminal electrode connected to one end of the coil part and provided so as to protrude from the mounting surface; and a second terminal electrode connected to other end of the coil part and provided so as to protrude from the mounting surface. The insulating resin has a first exposed part positioned between the first and second terminal electrodes on the mounting surface and exposed so as to protrude from the mounting surface. Thus, excessive flowability of a solder is suppressed due to the presence of the first exposed part protruding from the mounting surface, thus making a flash phenomenon unlikely to occur.

In the above coil component, the element body may contain a first filler made of a magnetic material, and the insulating resin may contain a second filler having an average particle diameter smaller than an average particle diameter of the first filler particles. This enhances the flatness of the surface of the first exposed part, so that, when the coil component is mounted on a circuit board, a molding resin easily enters a space between the circuit board and the first exposed part.

In the above coil component, the protruding amount of each of the first and second terminal electrodes from the mounting surface may be larger than the that of the first exposed part from the mounting surface. Thus, when the coil component is mounted on a circuit board, a space between the circuit board and the coil component is further enlarged, thus facilitating the entry of the molding resin.

In the above coil component, the plurality of conductor layers may include a first conductor layer positioned at one end side in the stacking direction, a second conductor layer positioned at the other end side in the stacking direction, and one or more third conductor layers positioned between the first and second conductor layers. A part of the first exposed part that is located in the stacking position same as the third conductor layer may have an exposed width larger than the exposed width of the remaining part of the first exposed part that is located in the stacking position same as the first and second conductor layers. This facilitates the formation of the element body.

In the above coil component, the boundary along the stacking direction between the mounting surface and the first exposed part may have an irregular shape. This enhances adhesion of the molding resin entering between the coil component and a circuit board on which the coil component is mounted.

In the above coil component, the element body may further have an upper surface positioned on the opposite side of the mounting surface, and the insulating resin may further have a second exposed surface exposed from the upper surface. This can enlarge the diameter of a coil pattern constituting the coil part.

What is claimed is:

1. A coil component comprising:
an element body having a mounting surface;
a coil part embedded in the element body, the coil part including a plurality of conductor layers stacked in a stacking direction parallel to the mounting surface;
an insulating resin positioned between the element body and the coil part;
a first terminal electrode connected to one end of the coil part and provided so as to protrude from the mounting surface; and
a second terminal electrode connected to other end of the coil part and provided so as to protrude from the mounting surface,
wherein the insulating resin has a first exposed part positioned between the first and second terminal electrodes on the mounting surface and exposed so as to protrude from the mounting surface.

2. The coil component as claimed in claim 1,
wherein the element body contains a first filler made of a magnetic material, and
wherein the insulating resin contains a second filler having an average particle diameter smaller than an average particle diameter of the first filler particles.

3. The coil component as claimed in claim 1, wherein a protruding amount of each of the first and second terminal electrodes from the mounting surface is larger than a protruding amount of the first exposed part from the mounting surface.

4. The coil component as claimed in claim 1,
wherein the plurality of conductor layers include a first conductor layer positioned at one end side in the stacking direction, a second conductor layer positioned at other end side in the stacking direction, and one or more third conductor layers positioned between the first and second conductor layers, and
wherein a part of the first exposed part that is located in a stacking position same as the third conductor layer has an exposed width larger than an exposed width of remaining part of the first exposed part that is located in a stacking position same as the first and second conductor layers.

5. The coil component as claimed in claim 1, wherein a boundary along the stacking direction between the mounting surface and the first exposed part has an irregular shape.

6. The coil component as claimed in claim 1,
wherein the element body further has an upper surface positioned on an opposite side of the mounting surface, and
wherein the insulating resin further has a second exposed surface exposed from the upper surface.
